(19) United States
(12) Patent Application Publication
(10) Pub. No.: US 2013/0161963 A1
(43) Pub. Date: Jun. 27, 2013

(54) MOTOR VEHICLE DOOR GRIP WITH CAST ELECTRONIC COMPONENT

(71) Applicant: Marion Kilian, Velbert (DE)

(72) Inventor: Marion Kilian, Velbert (DE)

(21) Appl. No.: 13/712,703

(22) Filed: Dec. 12, 2012

(30) Foreign Application Priority Data
Dec. 21, 2011 (DE) 10 2011 056 818.2

(51) Int. Cl. E05B 3/00

(52) U.S. Cl. CPC E05B 3/00
USPC 292/336.3

(57) ABSTRACT

A door grip arrangement for motor vehicles with an elongated handle, includes a handle body and a handle cover. A cavity is formed in the handle body. Electronic components are received in the cavity, wherein the electronic components are at least partially cast around with casting compound. Transversely to the longitudinal extent of the handle, at least one dividing wall is arranged in the handle body, so that the dividing wall divides the handle body into several chambers, with at least one cavity being located in each chamber. The cavities are open to a side of the handle which is oriented towards the handle cover. At least one of the chambers receives electronic components which are cast around with casting compound such that the dividing wall forms a boundary for the casting compound.

The invention relates to a motor vehicle door grip with a cast electronic component. The invention relates in particular to a door grip arrangement with a handle, wherein in the handle a cavity receives an electronic component and after introduction of the electronic component the cavity is cast with a casting compound.

Motor vehicle door grips of the named type are known in the prior art. DE 10 2009 009 396 A1 discloses a corresponding door grip with a handle, wherein electronic components are arranged in the handle. In the said handle a filling element is provided, by which casting compound is able to be introduced into the cavity with the components.

It is known that in the filling of openings with casting compounds, gas inclusions can occur, which can lead to corrosion problems on the cast-in electronic components. On the other hand, the use of casting compound increases the overall weight of the grip arrangement and the hardening of the casting compound extends the production time of a grip arrangement.

It is an object of the present invention to provide a grip arrangement which, with consistent functionality, is optimized with regard to weight and permits a quick production.

This problem is solved according to the invention by the features of Claim 1.

The grip arrangement according to the invention has a handle with a handle body and a handle cover. The handle body receives electronic components, in particular cables, antennae and control elements. The handle cover covers the open space of the handle body and protects the latter from access by the user and from environmental influences.

According to the invention, in the handle body along the longitudinal extent of the handle at least one dividing wall is constructed, arranged transversely to the longitudinal extent of the handle. The dividing wall separates several longitudinal sections of the handle body from one another. Each of the chambers contains at least one cavity in which components can be accommodated. Electronic components which are to be cast are arranged in a section of the handle body and this section is filled with casting compound, so that the electronic components are cast in.

In the handle body a chamber system is constructed accordingly, wherein the dividing walls prevent the overflowing of the casting compound into other sections of the handle body. The dividing walls form a boundary for the spreading of the casting compound. Along the longitudinal extent of the handle body, sections are formed accordingly with cast electronic components and non-cast electronic components. In handles hitherto, electronic components were surrounded by casting compound even when this was not absolutely necessary. The separation of various regions in a handle body and a casting of only some of these regions reduces the overall weight of the arrangement. In addition, some electronic components still remain accessible, namely the non-cast electronic components. This continuing accessibility can facilitate the maintenance or the repair of corresponding door grip systems.

It is possible, in addition, to also use different casting compounds for different regions through the dividing of the handle body into chambers. New possibilities are opened up for the mounting of such a grip, because the grip can be mounted during its production in sections, wherein the sections are gradually finally fixed by casting.

Preferably chambers, in particular at least one of the chambers, remain free of casting compound, whereas other chambers are filled with casting compound.

Those components which are either to remain accessible or are non-sensitive to acting influences are received in the uncast chamber. In addition, components can also be received whose function could be negatively influenced by casting, e.g. antenna devices.

Provision can be made that the dividing wall in the handle body has recesses through which conductors or cables can be directed from one chamber to the chamber the other side of the dividing wall. These recesses can be adapted in their size to the cables which are to be used, such that the recesses are completely closed by the cable which is directed through. These recesses can also be arranged in the margin region of the wall, e.g. as depressions in a dividing wall edge, via which the cables are directed.

In a further development of the invention, the separated chambers can also provide respectively filling elements, by which the casting compound is able to be filled from the exterior into the corresponding cavity of the chamber. Corresponding concepts are disclosed in the above-mentioned publication.

In addition to the function of delimiting the flow region of the casting compound, the dividing wall in the handle body in addition offers a possibility of spatial fixing of components during the mounting of the system. The dividing walls can be used as an abutment or as an aid against a slipping of the components, and can provide a guidance and retaining of the cable to be laid through the handle. The recesses which are constructed prevent cable break here and offer a reproducible guidance, which likewise is conducive to the problem-free and quick mounting.

The invention is now explained in further detail with the aid of the enclosed drawings.

FIG. 1 shows a perspective view of a door grip according to the invention in accordance with a first example embodiment;

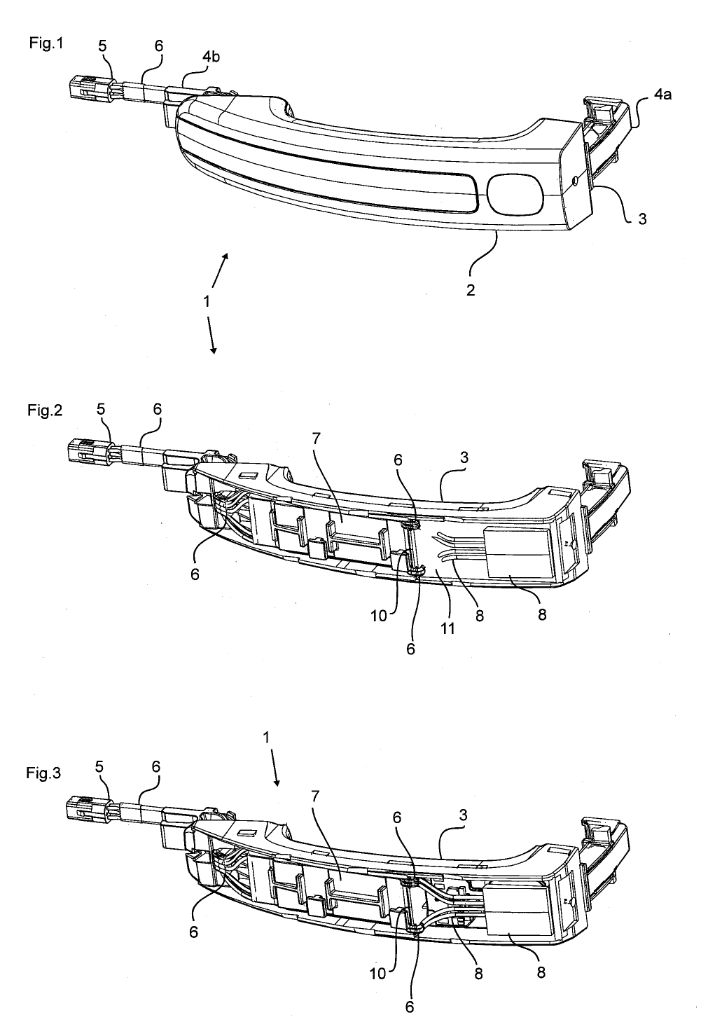

FIG. 2 shows the door grip of FIG. 1 with dismantled handle cover and exposed view onto the cast electronics;

FIG. 3 shows the door grip of FIGS. 1 and 2, before the casting of the electronic components;

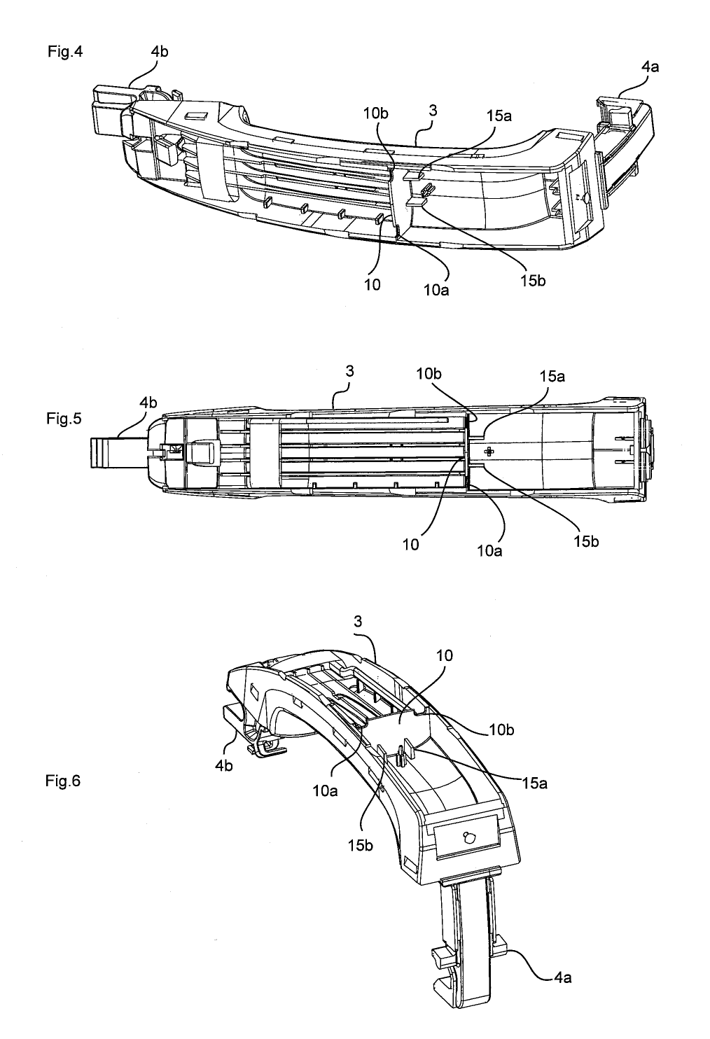

FIG. 4 shows the handle body in accordance with the door grips of FIGS. 1, 2 and 3;

FIG. 5 shows the handle carrier of FIG. 4 in a top view;

FIG. 6 shows the handle carrier of FIGS. 4 and 5 from another angle of view.

In FIG. 1 a handle 1 for a door grip arrangement is shown. In this view, the handle cover 2 can be seen, which contains various operating components and functional parts. The cover 2 is coupled with the handle body 3, which is described in further detail in the following drawings. Mechanical projections 4a and 4b are situated on the handle body, which on mounting on a motor vehicle engage through recesses in door plates and are coupled with a grip carrier. In addition, a plug connector 5 is coupled with a cable harness 6, wherein the cables lead into the interior of the handle body.

FIG. 2 exposes the view onto the handle body 3, wherein the handle cover 2 has been removed. Various functional components are arranged in the interior of the handle body 3, which are coupled with the plug connector 5 via the cables 6. An assembly 7 and an assembly 8 are situated at different positions along the longitudinal extent of the handle body. A dividing wall 10 is constructed between the components 7 and 8 in the handle body. The dividing wall 10 separates various chambers along the longitudinal extent of the carrier body 3. One of the chambers is filled with a casting compound 11, so that the assembly 8 is at least partially cast around and hence protected from environmental influences. Some of the cables 6 lead away over the dividing wall 10, which will be further explained in detail later.

It can be seen that the filling with the casting compound 11 takes up a distinctly smaller region or space than when filling the entire grip interior, wherein also the components 7 would be cast around.

The dividing wall 10 also prevents a running of the casting compound 11 into the region in which the components 7 are arranged.

FIG. 3 shows the arrangement of FIG. 2, wherein here the casting compound 11 has been removed, i.e. in a state before the casting of the components 8. In this illustration, the arrangement of the dividing wall 10 for the separating of several chambers in the handle body 3 can be readily seen. It can likewise be seen how the cables 6 are guided over the dividing wall 10. It is fundamental that along the longitudinal extent by transverse walls several receiving chambers are formed with cavities in the handle body.

FIG. 4 shows the handle body 3, wherein further inner components are removed. In this illustration, the arrangement of the dividing wall 10 with the recesses 10a and 10b becomes clear. To receive electronic components, a chamber is formed by the dividing wall 10, which chamber only takes up a portion of the longitudinal extent of the handle body 3. The recesses 10a and 10b offer space for the cables which are guided through longitudinally along the extent of the handle (see FIGS. 2 and 3) and fix the position of the cables before the process of casting in a transverse direction to the longitudinal extent of the handles. Projections 15a and 15b are constructed on the dividing wall itself, which offer holding means and supports for the electronic components 8. In the non-cast interior of the carrier, i.e. the region to the left of the dividing wall in FIG. 7, longitudinal struts are arranged for stabilization and for guiding of the cables.

FIGS. 5 and 6 show the handle body 3 of FIG. 4 in other views, wherein here the position and constructions of the dividing wall 10 and of the recesses 10a and 10b can be readily seen.

Within the scope of the invention, further chambers can be constructed in the handle body. The various chambers can, in addition, be all completely cast, wherein the process of casting, e.g. can also take place with different casting compounds or at different times of the manufacturing process. In each case, a dividing wall running transversely to the longitudinal extent of the handle body prevents casting compound from arriving into regions which are not to be cast at this time. In so far as not all regions are cast, the result is a door grip which is reduced in weight and is easy to manufacture.

The dividing walls can, moreover, be constructed integrally with the handle body, but they can also be placed inserted in mounts or guides of the handle body.

1. A door grip arrangement for motor vehicles with an elongated handle, which has a handle body and a handle cover,
wherein in the handle body a cavity is formed, in which electronic components are received, wherein the electronic components are at least partially cast around with casting compound,
characterized in that
transversely to the longitudinal extent of the handle at least one dividing wall is arranged in the handle body, so that the dividing wall divides the handle body into several chambers with respectively at least one cavity, wherein the cavities are open to the side directed to the handle cover,
wherein at least one of the chambers receives electronic components which are cast around with casting compound such that the dividing wall forms a boundary for the casting compound.

2. The door grip arrangement according to claim 1, wherein at least one of the chambers if free of casting compound.

3. The door grip arrangement according to claim 1, wherein in the dividing wall at least one recess is formed, which forms an abutment for cable guidance.

4. The door grip arrangement according to claim 3, wherein the recess is constructed in the margin region of the dividing wall facing the handle cover.

5. The door grip arrangement according to claim 1, wherein holding- or support elements for the received electronic components are constructed on the dividing wall.

6. The door grip arrangement according to claim 1, wherein in at least one of the chambers a foam material is arranged between handle cover and handle body in contact with the handle cover.
